(19) United States
(12) Patent Application Publication
(10) Pub. No.: US 2017/0023925 A1
(43) Pub. Date: Jan. 26, 2017

(54) EtherMark/IP Marking System

(71) Applicant: Mecco Partners, LLC, Cranberry Twp., PA (US)

(72) Inventors: David Morgan Sweet, Gibsonia, PA (US); Pavel Kyn, Brookline, MA (US); Robert Herman Flanagan, Wayland, MA (US); Simon Robb Kohnstamm, Pittsburgh, PA (US)

(21) Appl. No.: 15/285,663

(22) Filed: Oct. 5, 2016

Related U.S. Application Data
(63) Continuation of application No. 13/963,052, filed on Aug. 9, 2013, now abandoned.

(51) Int. Cl. G05B 19/05; B41M 5/24; B25H 7/04

(52) U.S. Cl. CPC G05B 19/05; B25H 7/04; B41M 5/24; G05B 2219/1214

(57) ABSTRACT

The invention is a system that facilitates integration of laser or dot peen marking systems into factory automation networks using the standard EtherNet/IP protocol. Built-in support for the EIP protocol greatly simplifies the PLC programming task, and lowers the cost of integrating the marking system into factory operations.

### FIELD OF INVENTION

Relates to providing industry standard communication interface to marking systems.

### BACKGROUND

Many automation industries have requirements for parts of products to be marked such as automotive, defense, aerospace, metalworking and fabrication, assembly, and medical device industries. Direct part marking, laser marking, laser engraving and dot peen machines are used to mark parts for traceability and part verification. Current systems use a programmable logic controller (PLC) to send commands to a marker machine controller using the command structure dictated by the marker supplier's proprietary API Protocol. A PLC is a specialized computer used to control machines and processes. PLCs use a programmable memory to store instructions and specific functions that include on/off control, timing, counting, and data handling. Ladder logic is widely used to program PLCs, where sequential control of a process or manufacturing operation is required. Ladder logic represents a program by a graphical diagram based on the circuit diagrams of relay logic hardware. Ladder logic has been adopted because a wide variety of engineers and technicians are able to understand it and use it with little training. Ladder logic is useful for simple but critical control systems. Often the ladder logic program is used in conjunction with an HMI (Human Machine Interface) program operating on a computer workstation.

Ladder logic can be thought of as a rule-based language rather than a procedural language. A “rung” in the ladder represents a rule. When implemented with relays and other electromechanical devices, the various rules “execute” simultaneously and immediately. When implemented in a programmable logic controller, the rules are typically executed sequentially by software, in a repeating loop (scan). By executing the loop fast enough, typically many times per second, the effect of simultaneous and immediate execution is achieved to within the tolerance of the time required to execute every rung in the “loop” (the “scan time”). PLCs have a fast response time. PLCs operate in real time which means that an event taking place in the field will result in an operation or an output. The control program can also be watched in real time as it executes to find and fix problems. PLCs can have fixed or modular I/O configurations. Modular I/O configurations give PLCs flexibility. A microprocessor is used for implementing the logic and controlling communications among the modules.

Current laser/dot peen marking systems employ supplier-specific proprietary APIs (Application Programming Interfaces). Here, a PLC programmer is required to learn the marking system's proprietary API command set and create custom code to perform basic marking operations. Writing custom communications code for PLC's is difficult, cumbersome and limits the functionality of the marking system. This problem is compounded because marking system API's are supplier-specific, and do not follow a universal standard. What is needed in the laser and dot peen marking industry is a system that reduces or eliminates the requirement for custom PLC programming to be written by a user for every specific supplier's marking system API protocol. Reducing custom PLC programming saves the user time and money.

EtherNet/IP (EIP) is a flexible application layer protocol that is specifically targeted to industrial automation and has been used to reduce custom PLC programming in various industries; saving the user time and money. However, EIP has not been employed previously in the automated marking industry. EIP is based on a widely implemented standard used in DeviceNet and ControlNet called the Control and Information Protocol (CIP). CIP allows EIP and DeviceNet product developers, system integrators, and users to apply the same objects and profiles for plug-and-play interoperability among devices from multiple suppliers and in multiple subnets. For a given device type, a minimum set of common objects operate. The user benefits from interoperability among devices regardless of the manufacturer or the device type. Laser and dot peen marking systems are general purpose devices from a variety of suppliers and they perform several functions; from simple to complex. The complex functional capability of marking systems has been an impediment to developing simpler methods for PLC programmers. In most cases, automated industrial marking does not employ the full functionality of a laser or dot peen marker. Often only a few fields of data are referenced and complex functions are unnecessary. This invention satisfies the need for a laser and dot peen marker with a simple interface that is easy to configure and use for PLC programmers.

### SUMMARY

The invention is a system that facilitates integration of laser or dot peen marking systems into factory automation networks using the standard EtherNet/IP protocol. It significantly reduces the need for custom PLC programming. This invention utilizes the industry standard EtherNet/IP protocol by applying it to different suppliers laser and dot peen marking systems.

### SHORT DESCRIPTION OF FIGURES

FIG. 1 depicts a high level view of how currently supplied marking systems interface with factory automation networks.

FIG. 2 depicts a high level view of a preferred embodiment of an interfacing supplier marking system with a user factory automation network.

FIG. 3 is list of program sequence steps to control a marking system utilizing this invention.

FIGS. 4 and 5 show a list of program sequence steps, using prior art, to control a marking system.

### DETAILED DESCRIPTION

EtherNet/IP (EIP) is a flexible application layer protocol that is specifically targeted to industrial automation. EIP leverages the transport and control protocols used in traditional Ethernet including the Transport Control Protocol (TCP), Internet Protocol (IP), User Datagram Protocol (UDP), and the media access and signaling technologies found in off-the-shelf Ethernet interface cards. EIP is based on a widely implemented standard used in DeviceNet and ControlNet called the Control and Information Protocol (CIP). CIP provides a common object-oriented language for describing the nodes and services on a CIP network, whether the network is implemented using DeviceNet, ControlNet, EtherNet/IP, or any other compatible technology. This makes existing knowledge and expertise transferable, facilitating the replacement or upgrading of existing systems, and reducing the cost of training development and support personnel. It also means that firmware or software written in a high-level language can be re-used with little or no re-coding necessary. CIP also defines device profiles, which identifies the minimum set of objects, configuration options, and the I/O data formats for different types of devices. Devices that follow one of the standard profiles will have the same I/O data and configuration options, will respond to all the same commands, and will have the same behavior as other devices that follow that same profile.

The CIP protocol provides numerous advantages. Consistent device access means that a single configuration tool can configure CIP devices on different networks from a single access point without using supplier specific software. EIP provides improved response time and greater data throughput, EIP links devices from the sensor bus level to the control level to the enterprise level with a consistent application layer interface.

Implementing an EIP network is not without challenges. Two of the most important challenges to the first time user include training and network configuration. It is necessary to understand both the IT fundamentals and the automation network. Another challenge is proper network configuration. Planning Ethernet factory automation infrastructure is essential. Careful identification of all control loops, choosing the correct routers, switches and paths and documenting the network properly are requisites for a communications network to meet production goals and requiring little ongoing maintenance.

The present invention brings the power of both EIP and PLC technology to laser and dot peen marking systems by allowing PLC's to use EIP to control laser or dot peen marking systems. The invention simplifies communication to “one command” by the PLC for loading a laser job file, and one to mark a job file. Communication follows the Object Model structure that is defined in EIP. A protocol converter, residing on an off-the-shelf Serial to Ethernet server board has been developed to adapt EIP object model commands to proprietary API commands to control laser and dot peen controllers. This capability facilitates the integration of laser and dot peen marking systems into every automation industry that needs parts marked for traceability and verification.

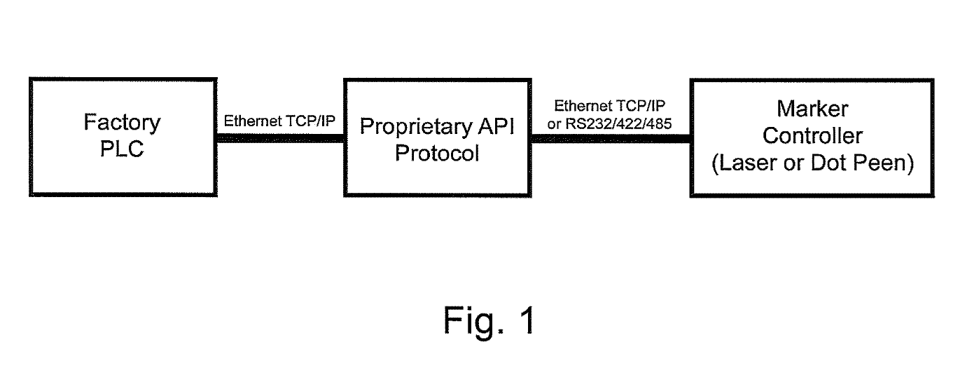

FIG. 1 depicts a high level view of how currently supplied marking systems interface with factory automation networks. The PLC sends commands to the supplier marker controller using the command structure dictated by the marking system's proprietary API protocol communicating via Ethernet. In this system the PLC programmer is required to learn the supplier marking system's proprietary API command set and create custom code to perform basic marking operations.

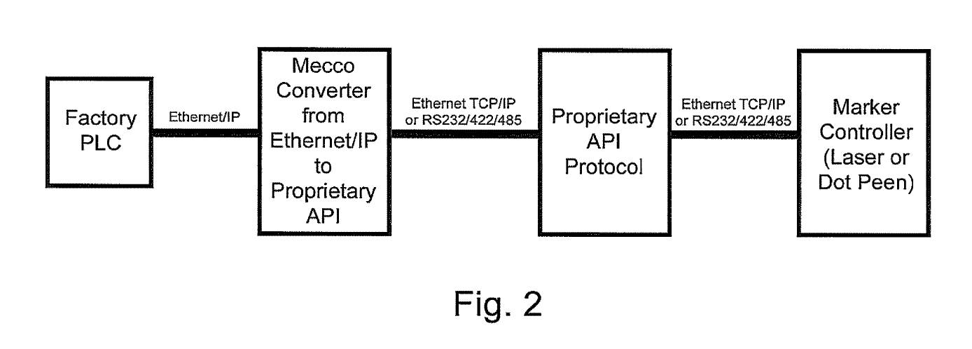

FIG. 2 depicts a high level view of a preferred embodiment wherein a supplier marking system interfaces with a user factory automation network. The user factory PLC sends commands using industry standard Ethernet/IP. Commands follow an object model structure defined by the EIP protocol, communicate via Ethernet. The converter code translates Ethernet/IP object model commands to proprietary API commands for the laser or dot peen controller.

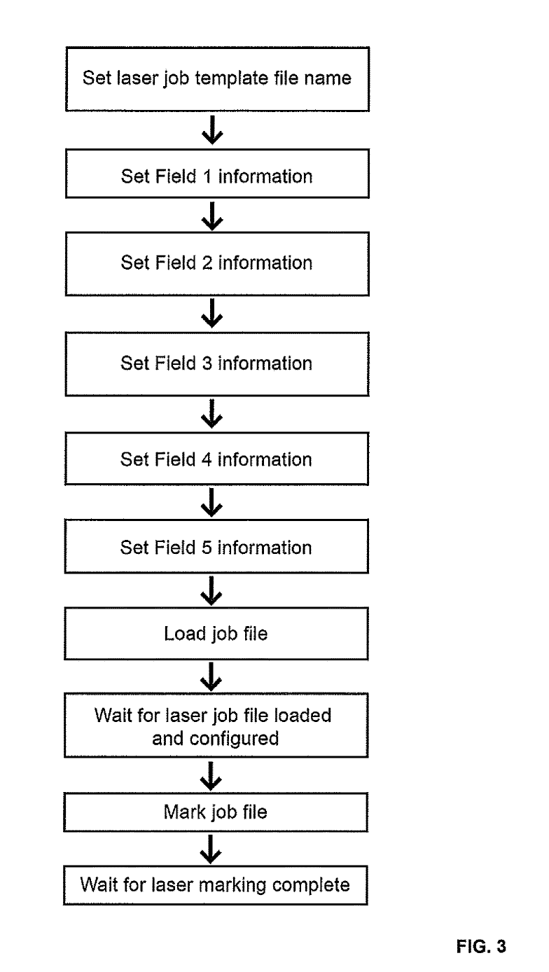

FIG. 3 is a program sequence to configure and mark a laser job using EtherNet/IP laser marker. The number of program steps is far fewer than what is needed for prior art systems. The number of steps using the invention have been reduced to those necessary to specify unique data that the user is supplying such as the job filename and field values, and to invoke basic “load job file” and “mark” commands. The user does not have to develop, test, and verify a custom communications “driver” to communicate with the marker.

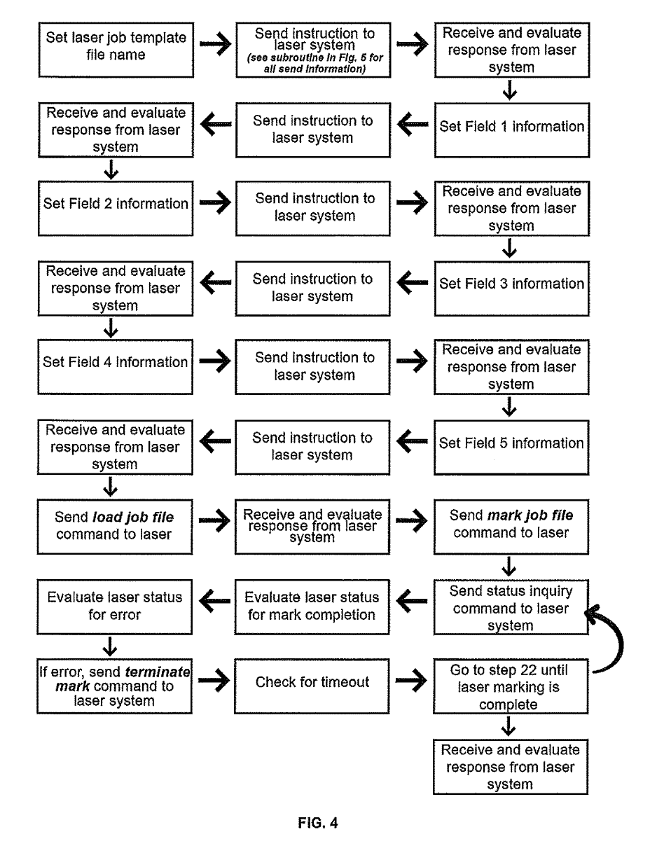

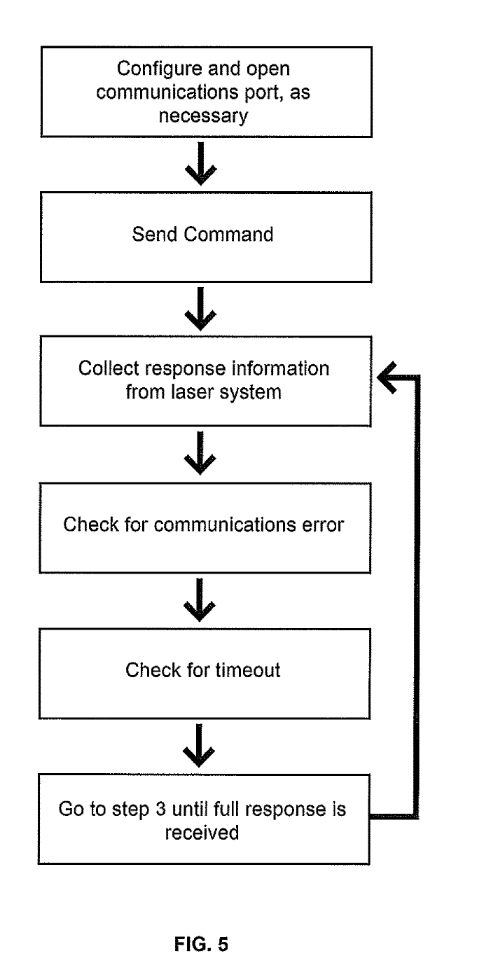

FIGS. 4 and 5 show a list of program sequence steps, using prior art, to control a marking system. FIG. 4 is a program sequence to configure and mark a laser job using serial or Ethernet commands to a laser marker. The user must program specific proprietary API commands for setting text fields, opening a job file, marking a job file, and terminating marking. FIG. 5 is a subroutine to send/receive commands from a laser system. A custom communications subroutine is required to connect to the marker, most likely using serial or raw Ethernet communications. The user is tasked with testing and verifying the low level communications code between the PLC and the marker.

This invention utilizes the industry standard EtherNet/IP protocol by applying it to different suppliers' laser and dot peen marking systems. The system adapts EIP object model commands to proprietary API commands for any laser or dot peen controller.

The system communicates over a common Ethernet network, with specific marking controllers, such as but not limited to, the LEC Laser Controller from LanMark Controls, and the MC-2000T2 Dot Peen Controller from Couth. The system implements the EtherNet/IP industrial protocol, and provides for firmware upgradeability via the Ethernet port.

Common marking controllers permit remote control over serial or Ethernet links, but do so using proprietary protocols, which require extra PLC programming effort to implement. The system of the present invention integrates a standard EIP communication interface into the marking controllers, and supervises and controls their operation. The system receives commands and data from a PLC via EIP, and translates them to the proprietary protocol used by the attached marking device. Built-in support for the EIP protocol greatly simplifies the PLC programming task, and lowers the cost of integrating the marking system into factory operations.

Besides the integration of the standard EIP protocol, the invention enhances the utility of the marking system by adding the following specific functionalities:

String Concatenation:

In a preferred embodiment there is a marking of long text strings by string concatenation, this solves the problem that EIP strings are limited at most to 512 bytes. The invention collects in its internal memory, text strings sent in consecutive EIP packets, and concatenates them into a single larger text string. This larger text string can then be marked.

Serial Number Duplication Prevention:

The invention may be furthered configured to protect against undesirable serial number duplication. The user can declare specific marker fields to contain “unique serial numbers”. The invention receives, and stores the content of these fields in its internal memory. When receiving a new EIP command to mark, the invention compares the content of these fields to the previously received content stored in its internal memory. If the content is identical, the invention prevents the marking process from starting, and raises a “duplicate serial number” or “uniqueness” fault.

Automatic Verification of Mark Quality:

The invention may be furthered configured to provide automatic verification of the quality of the mark created. Marks may contain machine readable information, in the form of 1D barcodes and 2D data matrix barcodes. The invention interfaces to a Cognex, or to a similar vision system, which visually inspects the mark just created, reads the encoded data, and grades the quality of the mark. If the vision system deems the mark of poor quality, the invention invokes an automatic remark capability.

Automatic Remark:

The invention may be furthered configured to provide an automatic remark capability. When the attached vision system deems a created mark to be of poor quality, the Automatic Remark feature follows a special remark procedure. This procedure employs dedicated remark information to obliterate (erase) the previous mark, and then performs a re-mark with different parameters. This process may be repeated more than once. Each repetition is graded for quality, which may cause a subsequent remark, or may raise a “mark quality failure” fault after a specified number of re-marks has been attempted.

The foregoing description merely illustrates the invention is not intended to be limiting. It will be apparent to those skilled in the art that various modifications can be made without departing from the inventive concept. Accordingly it is not intended that the invention be limited except by the appended claims.

1. A marking system for a laser or dot peen controller comprised of a controller wherein a PLC uses EIP to operate said controller.

2. The marking system of claim 1 whereby communication to the PLC is limited to one command for loading, and one command for configuring and marking a job file.

3. The marking system of claim 1 whereby communication follows an object model structure that is defined in EtherNet IP.

4. The marking system of claim 1 further comprising a protocol converter, the protocol converter adapting EtherNet/IP object model commands to proprietary API commands to operate the marking system.

5. The marking system of claim 1 whereby a marking of long text strings is accomplished by string concatenation.

6. The marking system of claim 5 wherein the text strings sent in consecutive EIP packets are concatenated into a single larger text string.

7. The marking system of claim 1 whereby undesirable serial number duplication is prevented.

8. The marking system of claim 7 whereby specific numeric fields are declared in an EIP packet to be unique serial numbers and are stored in internal memory.

9. The marking system of claim 8 further comprising: receiving a new OP packet to mark, comparing content of specific numeric fields to previously received content stored in internal memory; whereby if the content is identical, the marking process is prevented from starting and raises a fault.

10. The marking system of claim 1 whereby communication occurs through an Ethernet TCP/IP communication port and an RS232/422/485 serial communication port.

11. The marking system of claim 1, whereby the converter code translates EtherNet/IP object model commands to proprietary API commands for the controller.

12. The marking system of claim 1 wherein EIP object model commands adapts to proprietary API commands for any laser or dot peen controller.

13. The marking system of claim 1 wherein the EtherNet/IP industrial protocol is implemented and provides for firmware upgradeability via the Ethernet port.

14. The marking system of claim 1 wherein a standard EIP communication interface is integrated into marking controllers whereby their operation is controlled and supervised.

15. The marking system of claim 1 furthered configured to provide automatic verification of the quality of the mark created.

16. The marking system of claim 15 wherein the system interfaces to a vision system; said vision system visually inspects the mark just created, reads the encoded data, and grades the quality of the mark; whereby if the vision system deems the mark of sufficiently poor quality, the system invokes an automatic remark capability.

17. The marking system of claim 16 furthered configured to employ dedicated remark information to obliterate the previous mark, then to perform a re-mark with different parameters.

18. The marking system of claim 17 whereby employing dedicated remark information to obliterate the previous mark, then to perform a re-mark with different parameters is repeated, wherein each repetition is graded for quality.

19. The marking system of claim 18, whereby a mark quality failure fault is raised after a specified number of re-marks has been attempted.

20. The marking system of claim 1 wherein commands and data are received from a PLC via EIP, whereby said commands and data are translated to a proprietary protocol used by a specific marking controller.
